(19) United States
(12) Patent Application Publication
(10) Pub. No.: US 2004/0134051 A1
(43) Pub. Date: Jul. 15, 2004

(54) Thread milling or cutting tool and method for the production thereof

(76) Inventors: Helmut Glimpel, Lauf (DE); Ernst Meyer, Lauf (DE)

Correspondence Address: R. William Beard, Jr., Baker Botts L.L.P., 910 Louisiana, One Shell Plaza, Houston, TX, 77002, US

(21) Appl. No.: 10/688,150

(22) Filed: Oct. 17, 2003

(30) Foreign Application Priority Data
Oct. 19, 2002 (DE) 102 48 815.0

(51) Int. Cl. B23P 11/02

(52) U.S. Cl. 29/33 K; 407/48; 409/234; 29/447

(57) ABSTRACT

A thread milling or cutting tool (1) comprises a carrier piece (2) rotatable around an axis of rotation (D), at least one cutting element (3, 3′, 3″, 3′″) releasably attachable or attached on the carrier piece (2), and at least one fastening element (4, 4′, 4″, 4′″) releasably attachable or attached on the carrier piece (2), wherein at least one cutting element (3, 3′, 3″, 3′″) has no hole for attachment by means of a fastening screw, but is positively and/or non-positively attachable or attached between the carrier piece (2) and at least one fastening element (4, 4′, 4″, 4′″) and/or between at least two fastening elements.

### PRIORITY

This application claims foreign priority of the German application DE 10248815.0 filed on Oct. 19, 2002.

### TECHNICAL FIELD

The invention concerns a thread milling or cutting tool. Furthermore, the invention concerns a method for producing such a thread milling or cutting tool.

### BACKGROUND OF THE INVENTION

Thread milling or cutting tools in accordance with the invention are required, for example, in order to cut a thread into the outer surface of a bolt-like section. A previously known thread milling tool has a rotating carrier piece for this, cutting elements being located in an axial end area thereof. The latter have an essential prismatic configuration and have a continuous hole in the middle area. This is used for mounting the cutting element on the carrier piece by means of a screw. For an exact positioning of the cutting element on the carrier body the latter has at least radial contact surfaces on the carrier piece, contact surfaces in the circumferential direction and axial contact surfaces for the individual cutting elements. For example such a tool is known from DE 199 58 636 A1.

In the case of the previously known cutting tools the following circumstance has proved to be disadvantageous: in the case of many cases of application it is necessary that the thread milling or cutting tool be made as radially small as possible in the case of cutting an external thread. This may be necessary namely when external threads are to be cut on adjacent bolts, that are located beside one another with a small separation. In this case it is necessary to be able to have access to a tool that has a small radial extent in order to perform the thread cutting process.

This is not the case with the known thread milling or cutting tools. For a reliable attachment of the cutting elements on the carrier piece the latter have sufficient width in order to be able to be reliably fixed by the screw. This provides a minimal width of the cutting element. In the case of cutting an external thread of a cylindrical bolt this means that previously known thread milling or cutting tools have a relatively large external diameter on the thread diameter to be cut.

### SUMMARY OF THE INVENTION

Therefore the object of the invention is to create a thread milling or cutting tool that overcomes the above-mentioned disadvantages, that is, with respect to the thread diameter to be cut has a smaller external diameter in comparison with the previously known solutions. Thus a simpler handling of the tool and an easier performance of the thread milling or cutting process should be possible.

This object can be achieved by a thread milling or cutting tool comprising a carrier piece rotatable around an axis of rotation, at least one cutting element releasably attachable or attached on the carrier piece and at least one fastening element releasably attachable or attached on the carrier piece, wherein at least one cutting element has no hole for attachment by means of a fastening screw, but is positively and/or non-positively attachable or attached between the carrier piece and the at least one fastening element and/or between at least two fastening elements.

The object can also be achieved by a thread milling or cutting tool comprising a carrier piece rotatable around an axis of rotation, at least one cutting element and at least one fastening element that is releasably attachable or releasably attached on the carrier piece via at least one connecting means, in particular a screw connection, wherein the at least one cutting element being positively and/or non-positively and releasably attachable or attached between the carrier piece and the at least one fastening element and/or between at least two fastening elements, and wherein each fastening element and each connecting means in each case being located outside the cutting element and in each case neither penetrates the cutting element nor is surrounded by the cutting element.

The advantage achieved with the invention in particular consists in the fact that a screw fastening of the cutting element itself may be avoided and therefore the cutting elements no longer need to have a hole for fastening by means of a fastening screw. The result of this is that narrower cutting elements may be used than in the case of the prior art. As a whole, this makes it possible to make thread milling and cutting tools that have a smaller external diameter in relation to the diameter of an external thread to be cut than is the case in the previously known solutions. The same obtains in the case of making an internal thread, it being possible to use the proposed tool to mill or cut threads with a smaller diameter than is the case with previously known tools. With this a more simple treatment of the tools and an easier performance of the thread milling or cutting process is possible.

Thus, in comparison with the previously known solutions the invention no longer provides for attaching the cutting elements to the carrier piece via screws, that are guided through holes in the cutting elements, but via the arrangement of special fastening elements, that also permit a positive or non-positive fastening of the cutting elements on the carrier piece without a hole in the cutting element. In this case it is both possible to fasten the cutting element between the carrier piece and the at least one fastening element as well as fastening the cutting element between at least two fastening elements without a direct contact between cutting element and carrier piece being necessary.

A further embodiment of the invention provides:

a carrier piece rotatable around an axis of rotation

at least one cutting element and

at least one fastening element that is releasably attachable or releasably attached on the carrier piece via at least one connecting means, in particular a screw connection,

the at least one cutting element being positively and/or non-positively and releasably attachable or attached between the carrier piece and the at least one fastening element and/or between at least two fastening elements,

each fastening element and each connecting means in each case being located outside the cutting element and in each case neither penetrates the cutting element nor is surrounded by the cutting element.

Further it may be provided that at least one fastening element in the released condition still is connected with the carrier piece, in particular via the connecting means, in particular with a separation. Further the at least one fastening element in the released condition may be completely releasable or released from the carrier piece.

An advantageous configuration of the invention consists in having the at least one cutting element clampable or clamped between the carrier piece and the at least one fastening element and/or between at least two fastening elements. The fastening of the cutting element thus takes place either by clamping the cutting element between carrier pieces and at least one fastening element or by clamping the cutting element between at least two fastening elements, without direct contact between cutting element and carrier piece being necessary.

A preferred further embodiment in this case provides that at least one fastening element is made at least in the clamping range with the cutting element as a clamping wedge and/or essentially prismatic, and/or exerts a clamping wedge action on the cutting element.

An efficient fastening of the cutting element on the carrier piece may be assured by having the cutting element and fastening element are in contact on a plane that extends in the direction of the axis of rotation and forms an angle with the radial direction. Preferably the angle lies in the range between 10° to 30°.

A positive fastening of the cutting element may be achieved by having the fastening element embrace the cutting element in the radial direction and press against the carrier piece in the assembled condition of the latter.

A further advantageous configuration of the invention consists in having the carrier piece for the or each cutting element have a bearing surface in the radial direction and/or at least one bearing surface in the circumferential direction and/or at least one bearing surface in the axial direction and that the cutting element may be fastened or is fastened in the radial direction and/or the bearing surface in the circumferential direction and/or the bearing surface in the axial direction. For a precise positioning of the cutting elements the bearing surfaces for mounting the cutting element in the radial direction, circumferential direction, and/or axial direction onto the carrier piece elements may be polished.

An alternative embodiment of the tool in accordance with the invention is based on the following concept: the fastening element may have threaded section for the connecting means capable of being screwed into the carrier piece and a clamping section. In this case it may be provided that the cutting element has a recess made in the edge area in an area of contact with the fastening element, in particular a circular segmented recess. Namely it may be provided that the recess is made as a whistle notch or Weldon gripping surface.

In connection with this configuration it may be provided to mount a round extension on the cutting element on its end located opposite the cutting edge, into which a lateral, circular segment-like recess is made. This round-rodlike extension then may be inserted into a correspondingly made cylindrical recess in the carrier piece; a clamping screw may be inserted radially on the tangential recess in the round extension by means of a further hole in the carrier piece, which clamps the cutting element. The tangential recess may—as mentioned—as a whistle notch or Weldon. The fastening element in the form of the named fixing screw then pushes with its face side on the tangential recess in the round extension of the cutting element. In the case of a whistle notch the clamping surface is somewhat inclined.

A particularly advantageous design follows from the following configuration: the carrier piece may consist of two carrier piece elements, that preferably in each case are made rotation-symmetrical. The one carrier piece element in this case advantageously has at least one receiving section for receiving and holding the at least one cutting element. Furthermore the receiving section has at least one support for the cutting element extending in the axial direction.

Especially preferably the one carrier piece element for the cutting element has the bearing surface in the radial direction and the bearing surface in the circumferential direction, while the other carrier piece element for the cutting element has the bearing surface in the axial direction. In this way a particularly simple preparation of the bearing surfaces is possible.

In addition, a carrier piece element may have a cylindrical cross-section, that may be located in a hole in the other carrier piece element. A precise positioning of both carrier piece elements may be achieved by having a pressure fitting present between the cylindrical section of the one carrier piece element and the hole of the other carrier piece element. This may be produced advantageously by means of a shrinking process. Alternatively the connection between the two carrier piece elements also may be made by means of a screw connection.

Tools may be changed quickly by means of the fact that the thread milling or cutting tool is equipped with a quick action system on its axial end turned away from the at least one cutting element. In this case preferably a quick action tool system with a hollow chucking wedge is used.

Supply holes and/or supply grooves, via which the area of the cutting element may be supplied with cutting oil, are made in the carrier piece, may be provided for a good supply of the cutting point of the cutting element with cutting oil. In this case in particular it may be provided that a relief groove may be made for the cutting element between the radial bearing surface and the bearing surface in the circumferential direction in the carrier piece that serves as the supply groove.

The cutting elements used may have more than one cutting area, whereby in the case of wear of a cutting edge the cutting element may be reusable by turning.

Further, the cutting element as a rule will project with one side axially over the carrier piece. In connection with the provision of the already mentioned receiving recess with support bars, there results a “bell-shaped” tool, that is very well suited for making external threads on cylindrical bolts. In this case the effective cutting edges of the cutting element are directed radially inward.

A method for producing the thread milling or cutting tool comprises the following steps:

a) producing a first carrier piece element, that has a receiving section for at least one cutting element as well as a cylindrical section axially connected to the receiving section;

b) producing a radial bearing surface and a bearing surface in the circumferential direction for the at least one cutting element on the first carrier element;

c) producing a second carrier piece element, that has a hole for receiving the cylindrical section of the first carrier element;

d) producing an axial bearing surface for the at least one cutting element on the second carrier piece element;

e) connecting the first and second carrier piece element fixedly after insertion of the cylindrical section into the hole.

In this case, in particular, it may be provided that the production of the bearing surfaces in accordance with steps b) and d) above is made by grinding. Further, there is a particularly good bond, when the first and second carrier piece elements are connected by means of thermal shrinking in accordance with step e) above.

Altogether this results in a simply made thread milling or cutting tool, that offers advantages for a number of applications and may be handled easily.

### BRIEF DESCRIPTION OF THE DRAWINGS

The drawing shows an embodiment of the invention. Here:

FIG. 1 shows a perspective view of a thread milling or cutting tool,

FIG. 2 shows a side view of the tool in accordance with FIG. 1,

FIG. 3 shows section A-B in accordance with FIG. 2,

FIG. 4 shows the partial front vies of the tool from the left side in accordance with FIG. 2 or FIG. 3,

FIG. 5 shows the complete front view of the tool from the left side in accordance with FIG. 2 or FIG. 3, and

FIG. 6 shows a perspective view of a thread milling or cutting tool in accordance with the prior art.

### DETAILED DESCRIPTION OF THE PREFERRED EMBODIMENTS

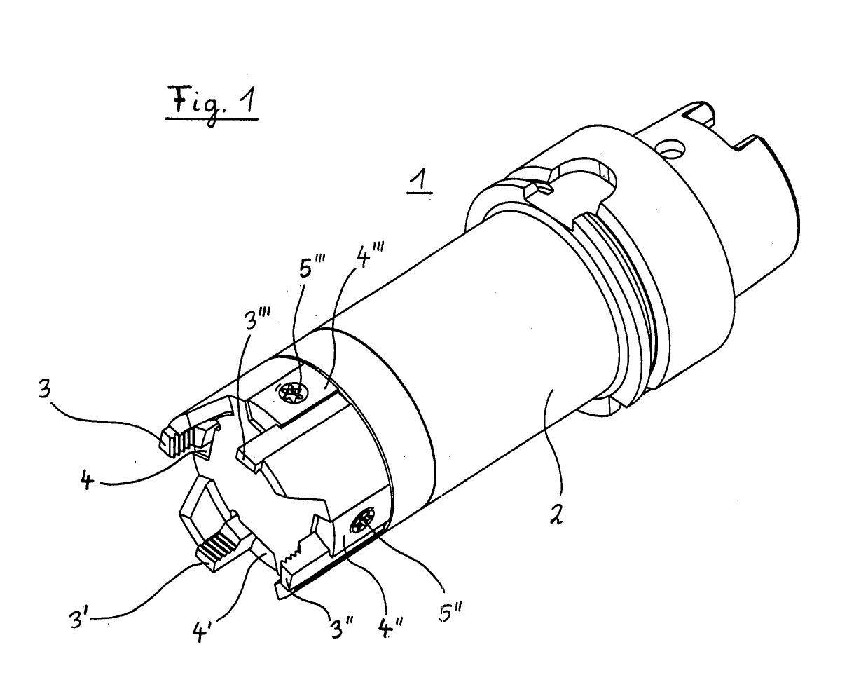

FIG. 1 shows a perspective view of a thread milling or cutting tool 1. It has a carrier piece 2, that is capable of rotating around the axis of rotation D. Four cutting elements 3, 3′, 3″. 3′″ are arranged uniformly distributed over the circumference in the left axial end area of the tool, that have cutting edges directed radially inward, with which a tool not shown may be provided with an external thread. The cutting elements 3, 3′, 3″, 3′″, are made essentially prismatic, and lie on bearing surfaces not shown, arranged radially, axially, and in the circumferential direction on the carrier piece 2. Fastening elements 4, 4′, 4″, 4′″, that are fastened by means of a screw connection 5, 5′, 5″, 5′″ on the carrier piece 2, are provided for fastening the cutting elements 3, 3′, 3″, 3′″. As will be described in detail later, the fastening elements 4, 4′, 4″, 4′″ fix the cutting elements 3,3′, 3″, 3′″ in the condition mounted on the carrier piece 2 so that the cutting elements are held firmly in position.

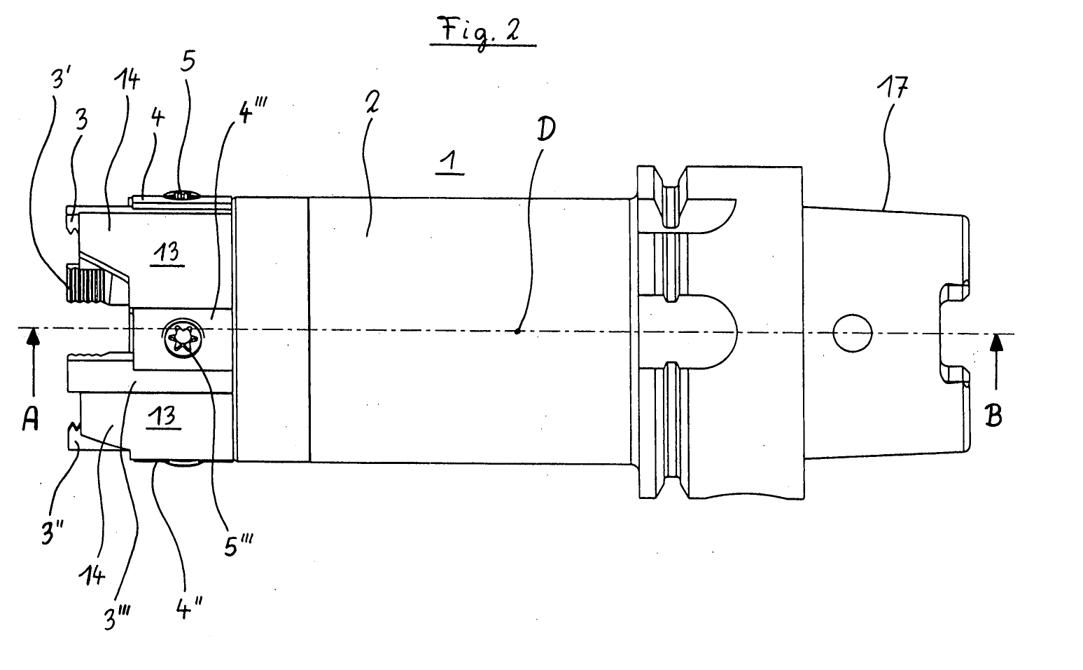

Details of the construction of the tool 1 may be seen in FIGS. 2 to 4.

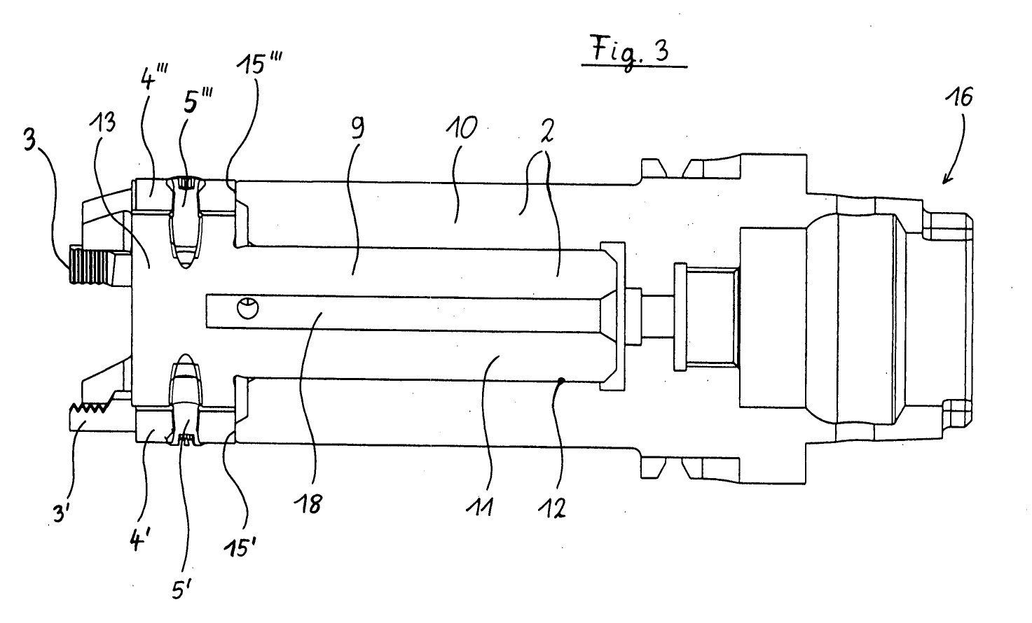

As is best shown in FIG. 3, the carrier piece 2 consists of two carrier piece elements 9 and 10. Carrier piece element 9 has a disk-shaped receiving section 13 as well as a cylindrical section 11 of smaller diameter connected axially with it. The carrier piece element 10 is made essentially as a hollow cylinder and has a hole 12 for receiving the cylindrical section 11 of the first carrier piece element 9. A quick action system 16 with a hollow clamping cone 17 (according to DN 69893) is located on the right axial end of the carrier piece element 10 (see FIGS. 2 and 3). A hollow clamping cone 17 is a clamping cone for clamping the tool 1, in the case of which in addition to the outer cone there are also inner clamping elements, that push elastically outward and thus reinforce the frictional connection and also follow-up a thermal expansion of the external cone.

The receiving section 13 of the first carrier piece element 9 has a support 14 for supporting each cutting element 3, 3′, 3″, 3′″, that extends in the axial direction. The respective cutting element 3, 3′, 3″, 3′″ lies against this, providing a precise and stable holding of the cutting elements.

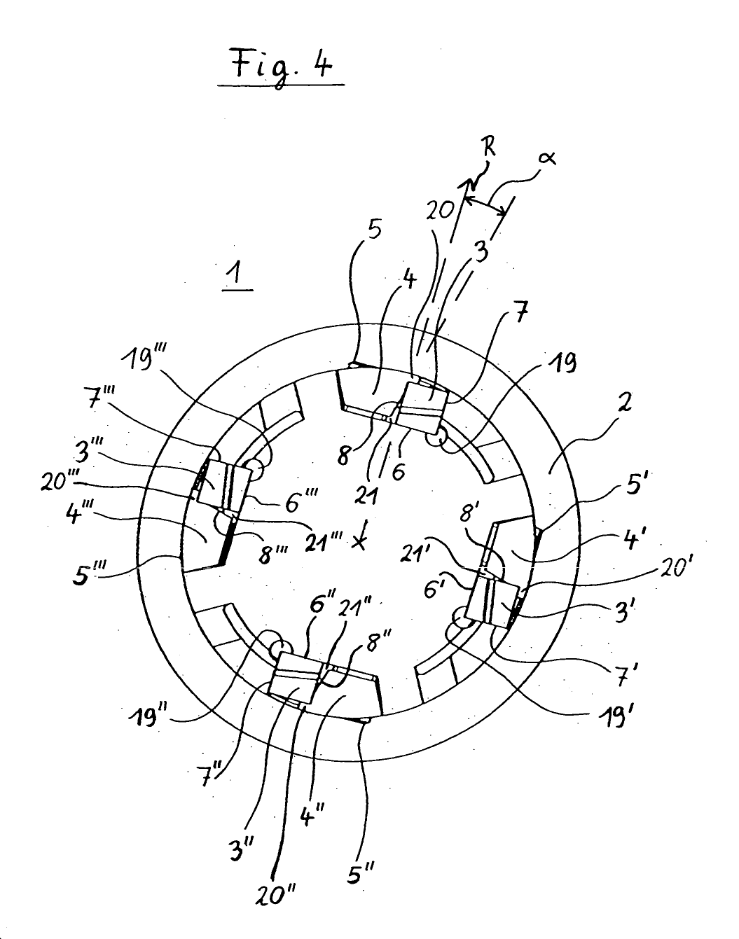

The receiving section 13—as is seen best in FIG. 4—has radial bearing sections 6, 6′, 6″, 6′″ as well as bearing surfaces in the circumferential direction 7, 7,′, 7″, 7′″, so that the individual cutting elements 3, 3′, 3″, 3′″ have a definitive and precise mounting in the carrier piece element 2. FIG. 3 shows that the carrier piece element 10 of the carrier piece 2 has a bearing surface in the axial direction 15, 15′, 15″, 15′″ on its left axial end.

Because of the possibility of forming the carrier piece 2 by means of the two carrier piece elements 9 and 10, it is technically possible to produce bearing surfaces 6, 6′, 6″, 6′″,7, 7′, 7″, 7′″, and 15, 15′, 15″, 15′″ in a particularly simple way, that is, namely to mill and then polish them. Groove bases play no role here, as would be the case with making the carrier piece 2 in one piece. Therefore the bearing surfaces are made with the carrier piece elements 9 and 10 dismantled.

In order to connect the two components 9 and 10, it has proved to be effective to heat the carrier piece elements 10 and/or to cool the carrier piece element 10, then to introduce the cylindrical section 11 into the hole 12 and then to have a temperature compensation take place. The two carrier elements 9 and 10 are connected with one another in this way by means of a thermal shrinking process, that, in particular, leads to the fact that the two parts are connected precisely with uniform frictional connection and without imbalance with one another; alternatively also the two parts 9 and 10 may be connected with one another via a screw connection.

As may be seen in particular in FIG. 4, the contact surfaces of the cutting elements 3, 3′, 3″, 3′″ and the fastening elements 4, 4′, 4″, 4′″ are made so that there is a plane 8, 8′, 8″, 8′″ that extends in the direction of the axis of rotation D and that includes an angle a to the radial direction R. In this way it is achieved that a high tensile force is exerted in the case of fastening the fastening element 4, 4′, 4″, 4′″ on the cutting element 3, 3′, 3″, 3′″ by means of the wedge action which appears, so that the cutting elements 3,3′, 3″, 3′″ are fixed both in the circumferential direction as well as radially on the carrier piece 2. FIG. 4 shows that the fastening elements 4, 4′, 4″, 4′″ in each case has a wrap-around 20, 20′, 20″, 20′″ radially gripping the cutting element 3, 3′, 3″, 3′″, with which a particularly good attachment of the cutting elements 3, 3′, 3″, 3′″ on the carrier piece can be made. However, wrap-arounds 20, 20′, 20″, 20′″ of this kind are not absolutely necessary in order to securely fasten the cutting elements 3, 3′, 3″, 3′″ on the carrier piece 2.

In order to supply the cutting or milling pint of the cutting elements 3, 3′, 3″, 3′″ with cutting oil the carrier piece 2 and namely the two carrier piece elements 9 and 10 have a centric supply hole 18, see FIG. 3, that in the area of is left axial end turns into radially extending holes, respectively supply grooves 18. As may be seen in FIG. 4, furthermore a relief groove 19, 19′, 19″, 19′″ may be provided in the area of the mounting of the cutting element 3, 3′, 3″, 3′″ on the carrier piece 2, in order to ensure the fitting of the two surfaces in contact. It is technically not possible to precisely make a 90° angle at this point. For this reason the relief groove 19, 19′, 19″, 19′″ is advantageous so that the cutting elements 3, 3′, 3″, 3′″ optimally abut each other. En each case there is a gap 21, 21′, 21″, 21′″, that is provided as a cutting oil entrance, between the cutting elements 3, 3′, 3″, 3′″ and the fastening elements 4, 4′, 4″, 4′″.

The thread milling or cutting tool 1 shown in the figures is provided for producing an external thread, therefore the cutting elements 3, 3′, 3″, 3′″ have their cutting edges directed radially inward. Precisely in this way, however, the tool also may be used for making internal threads, then the cutting edges of the cutting element 3, 3′, 3″, 3′″ having to be directed radially outward.

In the case of making an external thread the thread milling or cutting tool 1 is made as a bell-shaped tool in the area of the cutting elements 3, 3′, 3″, 3′″, therefore as a tool that can be set on the workpiece from outside. The threads to be made may be external threads, that project laterally from a larger workpiece. Since in many embodiments such external threads have to be made many times at relatively small distance from one another, it is important that the external diameter of the tool 1 remains as small as possible, which is assured by the measures proposed. The tool makes it possible—in comparison with the previously known solutions—to reduce the external diameter, since in the case of the prior art solutions the radial dimensions of the cutting element and the projection of the carrier piece always are added, but in the case of the proposed solution in practice the cutting elements form the outer surface.

Handling polished cutting elements also is very easy since the latter may be inserted radially from the outside ass well as axially from the front side of the tool.

Further advantages of the proposed invention are, in addition to the space-saving and compact design of the tool, are also that the cutting elements no longer have to be weakened as a result of drilling a hole for mounting by means of a fastening screw. This is particularly relevant, since the cutting elements for the most part consist of brittle material such as carbide, HSS (high-speed steel), CBN (cubic boron nitride), or PKD (polycrystalline diamond).

Therefore the cutting element may be obtained as a whole and, moreover, also be made smaller, since room for the screw hole no longer must be provided.

As in the case of the previously known solutions, the proposed tool also makes it possible to easily replace a worn cutting element with a new one. In addition, the cutting element also may have several cutting areas, in particular two, three, or four corners. Then the cutting element may simply be turned by 90° or 180° in the case of wear, so that the tool may be used again.

The embodiment explained concerns a tread milling or cutting tool for making a cylindrical external thread. However, it is also equally possible to provide the cutting edges of the cutting elements 3, 3′, 3″, 3′″ with other contours, so that the indentation of not only one thread may be produced. The cutting area of the cutting elements 3, 3′, 3″, 3′″ also may be inclined to the axis of rotation D, by means of which it is possible to provide conical bolts with a thread.

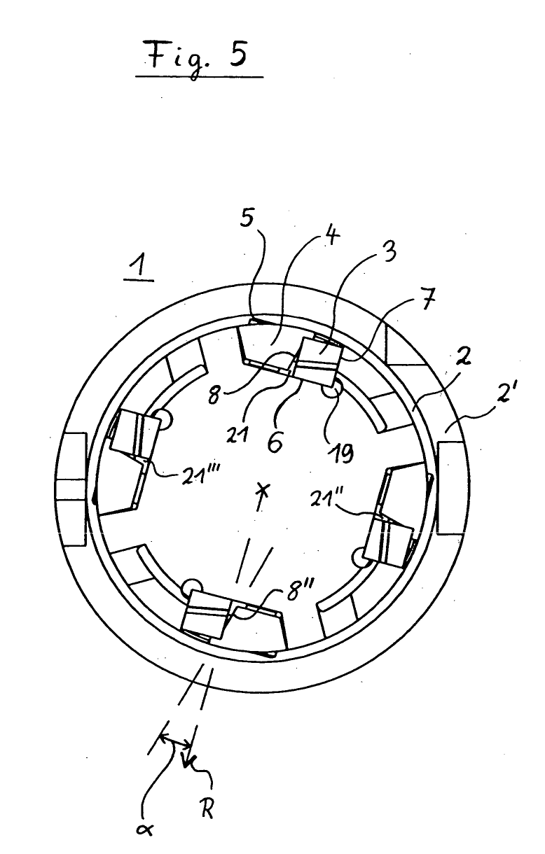

FIG. 5 shows a complete front view of the tool from the left side according to FIG. 2, respectively FIG. 3. FIG. 5 is essentially identical with FIG. 4, in FIG. 5 the structure of the outer area 2′ of the carrier piece 2 being shown. The edges of the recesses in the outer area 2′ of the carrier piece 2 are not shown in FIG. 4 for reasons of clarity of visualization. Thus FIG. 5 is a complete front view of the tool in accordance with FIG. 2 and FIG. 3.

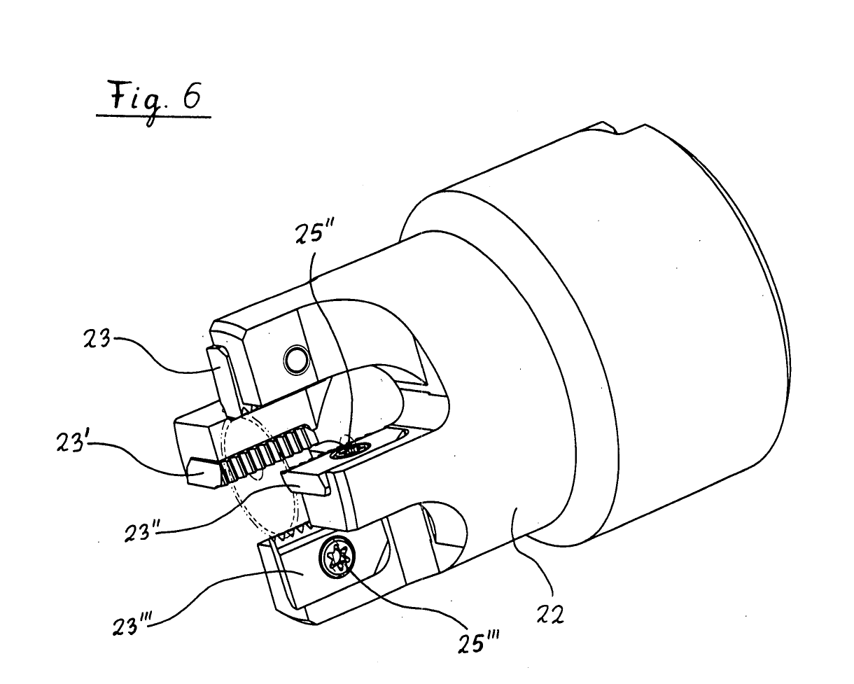

FIG. 6 shows a perspective view of a tool in accordance with the prior art. The tool includes a carrier piece 22, n which cutting elements 23, 23′, 23″, 23′″ are mounted. The cutting elements 23″ and 23′″ are screwed directly onto the carrier piece 22 by means of screw connections 25″ and 25′″. The cutting elements 23 and 23′ are mounted in the same way by means of screw connections not shown.

1. A thread milling or cutting tool comprising:
a) a carrier piece rotatable around an axis of rotation,
b) at least one cutting element releasably attachable or attached on the carrier piece, and
c) at least one fastening element releasably attachable or attached on the carrier piece, wherein
d) at least one cutting element has no hole for attachment by means of a fastening screw,
e) but is positively and/or non-positively attachable or attached between the carrier piece and at least one fastening element and/or between at least two fastening elements.

2. The thread milling or thread cutting tool in accordance with claim 1, wherein each fastening element lies in a fixed condition tightly against the associated cutting element for the outside, so that it fixes the cutting element, and in a released condition of the fastening element or elements the associated cutting element may be removed from the carrier piece.

3. The thread milling or cutting tool in accordance with claim 2, wherein at least one fastening element in the released condition is still connected with the carrier piece, in particular via the connecting means, in particular with separation.

4. The thread milling or cutting tool in accordance with claim 2, wherein at least one fastening element in the released condition may be removed or is removed completely from the carrier piece.

5. The thread milling or cutting tool in accordance with claim 1, wherein at the least one cutting element may be clamped or is clamped between the carrier piece and the at least one fastening element and/or between at least two fastening elements.

6. The thread milling or cutting tool in accordance with claim 5, wherein at least one fastening element is made as a clamping wedge and/or essentially prismatic at least in the area of clamping with the cutting element and/or exerts a clamping wedge action on the cutting element.

7. The thread milling or cutting tool in accordance with claim 1, wherein cutting element and fastening element are in contact on a plane that extends in the direction of the axis of rotation and encloses an angle with the radial direction.

8. The thread milling or cutting tool in accordance with claim 1, wherein the fastening element grips around the cutting element in the radial direction and pushes against the carrier element.

9. The thread milling or cutting tool in accordance with claim 1, wherein the carrier piece for the or each cutting element has at least one bearing surface in the radial direction and/or at least one bearing surface in the circumferential direction and/or at least one bearing surface in the axial direction and in the case of which the cutting element may be fastened or is fastened between the fastening element and the bearing surface in the radial direction and/or the bearing surface in the circumferential direction and/or the bearing surface in the axial direction, preferably each bearing surface being polished.

10. The thread milling or cutting tool in accordance with claim 1, wherein the fastening element has a threaded section that may be screwed into the carrier piece for the connecting means and a clamping section.

11. The thread milling or cutting tool in accordance with claim 1, wherein the cutting element in an area of contact with the fastening element has a recess, in particular a circular segment recess, located in the edge area, that is made, in particular, as a whistle notch or Weldon.

12. The thread milling or cutting tool in accordance with claim 1, wherein the carrier piece consists of two carrier piece elements, that preferably in each case are made essentially rotation symmetrical.

13. The thread milling or cutting tool in accordance with claim 12, wherein the one carrier piece element has at least one receiving section for receiving and holding the at least one cutting element, that preferably has at least one support for the cutting element, extending in the axial direction.

14. The thread milling or cutting tool in accordance with claim 12, wherein the carrier piece for the or each cutting element has at least one bearing surface in the radial direction and/or at least one bearing surface in the circumferential direction and/or at least one bearing surface in the axial direction and in the case of which the cutting element may be fastened or is fastened between the fastening element and the bearing surface in the radial direction and/or the bearing surface in the circumferential direction and/or the bearing surface in the axial direction, preferably each bearing surface being polished, and wherein the one carrier piece element for the cutting element has the bearing surface in the radial direction and the bearing surface in the circumferential direction and that the other carrier piece element for the cutting element has the bearing surface in the axial direction.

15. The thread milling or cutting tool in accordance with claim 12, wherein a carrier piece element has a cylindrical section, that may be located or is located in a hole in the other carrier piece element, preferably a pressure fitting being present between the cylindrical section of the one carrier piece element and the hole of the other carrier piece element, and/or the connection between the two carrier piece elements being made by means of a shrinking process or by means of a screw connection.

16. The thread milling or cutting tool in accordance with claim 1, with a quick action tool system on an axial end turned away from at least one cutting element, which quick action tool system preferably has a hollow clamping cone.

17. The thread milling or cutting tool in accordance with claim 1, wherein supply holes and/or supply grooves are made in the carrier piece, via which the area of the cutting element may be supplied or is supplied with cutting oil.

18. The thread milling or cutting tool in accordance with claim 17, wherein the carrier piece for the or each cutting element has at least one bearing surface in the radial direction and/or at least one bearing surface in the circumferential direction and/or at least one bearing surface in the axial direction and in the case of which the cutting element may be fastened or is fastened between the fastening element and the bearing surface in the radial direction and/or the bearing surface in the circumferential direction and/or the bearing surface in the axial direction, preferably each bearing surface being polished, and wherein an undercut, which serves as a feed groove, is made in the carrier piece between the radial bearing surface and the bearing surface in the circumferential direction for the cutting element.

19. The thread milling or cutting tool in accordance with claim 1, wherein at least one cutting element has at least two cutting areas and/or projects on one side axially over the carrier piece and/or has effective cutting edges directed radially inward.

20. A thread milling or cutting tool, comprising
a) a carrier piece rotatable around an axis of rotation,
b) at least one cutting element, and
c) at least one fastening element that is releasably attachable or releasably attached on the carrier piece via at least one connecting means, in particular a screw connection, wherein
d) the at least one cutting element being positively and/or non-positively and releasably attachable or attached between the carrier piece and the at least one fastening element and/or between at least two fastening elements, and wherein
e) each fastening element and each connecting means in each case being located outside the cutting element and in each case neither penetrates the cutting element nor is surrounded by the cutting element.

21. The thread milling or thread cutting tool in accordance with claim 20, wherein each fastening element lies in a fixed condition tightly against the associated cutting element for the outside, so that it fixes the cutting element, and in a released condition of the fastening element or elements the associated cutting element may be removed from the carrier piece.

22. The thread milling or cutting tool in accordance with claim 21, wherein at least one fastening element in the released condition is still connected with the carrier piece, in particular via the connecting means, in particular with separation.

23. The thread milling or cutting tool in accordance with claim 21, wherein at least one fastening element in the released condition may be removed or is removed completely from the carrier piece.

24. The thread milling or cutting tool in accordance with claim 20, wherein at the least one cutting element may be clamped or is clamped between the carrier piece and the at least one fastening element and/or between at least two fastening elements.

25. The thread milling or cutting tool in accordance with claim 24, wherein at least one fastening element is made as a clamping wedge and/or essentially prismatic at least in the area of clamping with the cutting element and/or exerts a clamping wedge action on the cutting element.

26. The thread milling or cutting tool in accordance with claim 20, wherein cutting element and fastening element are in contact on a plane that extends in the direction of the axis of rotation and encloses an angle with the radial direction.

27. The thread milling or cutting tool in accordance with claim 20, wherein the fastening element grips around the cutting element in the radial direction and pushes against the carrier element.

28. The thread milling or cutting tool in accordance with claim 20, wherein the carrier piece for the or each cutting element has at least one bearing surface in the radial direction and/or at least one bearing surface in the circumferential direction and/or at least one bearing surface in the axial direction and in the case of which the cutting element may be fastened or is fastened between the fastening element and the bearing surface in the radial direction and/or the bearing surface in the circumferential direction and/or the bearing surface in the axial direction, preferably each bearing surface being polished.

29. The thread milling or cutting tool in accordance with claim 20, wherein the fastening element has a threaded section that may be screwed into the carrier piece for the connecting means and a clamping section.

30. The thread milling or cutting tool in accordance with claim 20, wherein the cutting element in an area of contact with the fastening element has a recess, in particular a circular segment recess, located in the edge area, that is made, in particular, as a whistle notch or Weldon.

31. The thread milling or cutting tool in accordance with claim 20, wherein the carrier piece consists of two carrier piece elements, that preferably in each case are made essentially rotation symmetrical.

32. The thread milling or cutting tool in accordance with claim 31, wherein the one carrier piece element has at least one receiving section for receiving and holding the at least one cutting element, that preferably has at least one support for the cutting element, extending in the axial direction.

33. The thread milling or cutting tool in accordance with claim 31, wherein the carrier piece for the or each cutting element has at least one bearing surface in the radial direction and/or at least one bearing surface in the circumferential direction and/or at least one bearing surface in the axial direction and in the case of which the cutting element may be fastened or is fastened between the fastening element and the bearing surface in the radial direction and/or the bearing surface in the circumferential direction and/or the bearing surface in the axial direction, preferably each bearing surface being polished, and wherein the one carrier piece element for the cutting element has the bearing surface in the radial direction and the bearing surface in the circumferential direction and that the other carrier piece element for the cutting element has the bearing surface in the axial direction.

34. The thread milling or cutting tool in accordance with claim 31, wherein a carrier piece element has a cylindrical section, that may be located or is located in a hole in the other carrier piece element, preferably a pressure fitting being present between the cylindrical section of the one carrier piece element and the hole of the other carrier piece element, and/or the connection between the two carrier piece elements being made by means of a shrinking process or by means of a screw connection.

35. The thread milling or cutting tool in accordance with claim 20, with a quick action tool system on an axial end turned away from at least one cutting element, which quick action tool system preferably has a hollow clamping cone.

36. The thread milling or cutting tool in accordance with claim 20, wherein supply holes and/or supply grooves are made in the carrier piece, via which the area of the cutting element may be supplied or is supplied with cutting oil.

37. The thread milling or cutting tool in accordance with claim 36, wherein the carrier piece for the or each cutting element has at least one bearing surface in the radial direction and/or at least one bearing surface in the circumferential direction and/or at least one bearing surface in the axial direction and in the case of which the cutting element may be fastened or is fastened between the fastening element and the bearing surface in the radial direction and/or the bearing surface in the circumferential direction and/or the bearing surface in the axial direction, preferably each bearing surface being polished, and wherein an undercut, which serves as a feed groove, is made in the carrier piece between the radial bearing surface and the bearing surface in the circumferential direction for the cutting element.

38. The thread milling or cutting tool in accordance with claim 20, wherein at least one cutting element has at least two cutting areas and/or projects on one side axially over the carrier piece and/or has effective cutting edges directed radially inward.

39. A method for producing a thread milling or cutting tool comprising the steps:
a) producing a first carrier piece element, that has a receiving section for at least one cutting element as well as a cylindrical section axially connected to the receiving section;
b) producing a radial bearing surface and a bearing surface in the circumferential direction for the at least one cutting element on the first carrier element;
c) producing a second carrier piece element, that has a hole for receiving the cylindrical section of the first carrier element;
d) producing an axial bearing surface for the at least one cutting element on the second carrier piece element;
e) connecting the first and second carrier piece element fixedly after insertion of the cylindrical section into the hole.

40. The method in accordance with claim 39, wherein the bearing surfaces are made according to step b) and d) by grinding.

41. The method in accordance with claim 39, wherein the connection of the first and the second carrier piece element according to step e) is made by means of thermal shrinking.
